(19) United States
(12) Patent Application Publication
(10) Pub. No.: US 2008/0293389 A1
(43) Pub. Date: Nov. 27, 2008

(54) Method and system of forwarding SMS messages

(75) Inventors: Frances Mu-Fen Chin, Naperville, IL (US); John B. Reid, Naperville, IL (US); Alok Sharma, Lisle, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/805,771

(22) Filed: May 24, 2007

(51) Int. Cl. H04Q 7/20; H04M 3/42; H04Q 7/22

(52) U.S. Cl. 455/414.1; 455/412.1; 455/417; 455/466

(57) ABSTRACT

A method of forwarding messages in a wireless network is provided. The method comprises receiving a message destined for a first mobile station, processing the message based on call forwarding data to make a determination as to whether the message is to be forwarded to different mobile station, and transmitting the message to a message center responsive to the determination determining that the message is to be forwarded to a different mobile station.

### BACKGROUND OF THE INVENTION

The invention relates to a method and system for allowing a wireless subscriber to provision their desired short message forward-to number with the service provider and for allowing the short message to be delivered to that number. While it is particularly directed to the art of telecommunications, and will be thus described with specific reference thereto, it will be appreciated that the invention may have usefulness in other fields and applications.

By way of background, with the advent of the Internet, it has become easy to send messages to a large number of destinations at little or no cost to the sender. The messages include Short Message Service messages. Short Message Service (SMS) is a telecommunications protocol that allows the sending of “short” (160 characters or less) text messages. It is available on most digital mobile phones and on personal digital assistants with onboard wireless telecommunications. The individual messages which are sent are typically text messages.

Currently, the SMS messages cannot be forwarded to another wireless number. When a called party who activates call forwarding is busy or turned of, the incoming SMS message will not be forwarded. In this case, the Short Message Service Center (SMSC) will try to deliver the text message several times to the called party and then stop trying. With the availability of family calling plans shared across multiple handsets, this service fills a market demand to forward short messages between members on the same calling plan. The subscribers may desire to have all the family SMS messages received forwarded to another cell phone number in their family plan similar to currently available voice call forwarding scenarios.

The invention contemplates a new and improved method and system that resolves the above-referenced difficulties and others. In particular, the exemplary embodiment allows the wireless subscriber to provision their desired short message forward-to number and to allow the short message to be delivered to that number.

### SUMMARY OF THE INVENTION

The object of this invention is to provide an efficient and clean method and system which allows a wireless subscriber to receive a forwarded SMS message.

In one embodiment, a method of forwarding messages in a wireless network is provided. The method comprises receiving a message destined for a first mobile station, processing the message based on call forwarding data stored in a call forwarding database to make a determination as to whether the message is to be forwarded to different mobile station, and transmitting the message to a message center responsive to the determination that the message is to be forwarded to a different mobile station. In another embodiment, a message forwarding system for a wireless network is provided. The system comprises: a first network element that receives a message destined for a first mobile station, and a second network element that processes the message based on call forwarding data stored in a call forwarding database to make a determination as to whether the message is to be forwarded to different mobile station and transmits the message to a message center responsive to the determination that the message is to be forwarded to a different mobile station.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a communications network suitable for implementing aspects of the present invention;

FIG. 2 is a call forwarding table stored in a call forwarding database;

FIG. 3 is a memory layout of data stored in the call forwarding database;

FIG. 4 is a call flow diagram illustrating a method of provisioning the SMS message forward-to number; and

FIG. 5 is a call flow diagram illustrating a method of forwarding SMS messages in a communications network.

### DETAILED DESCRIPTION

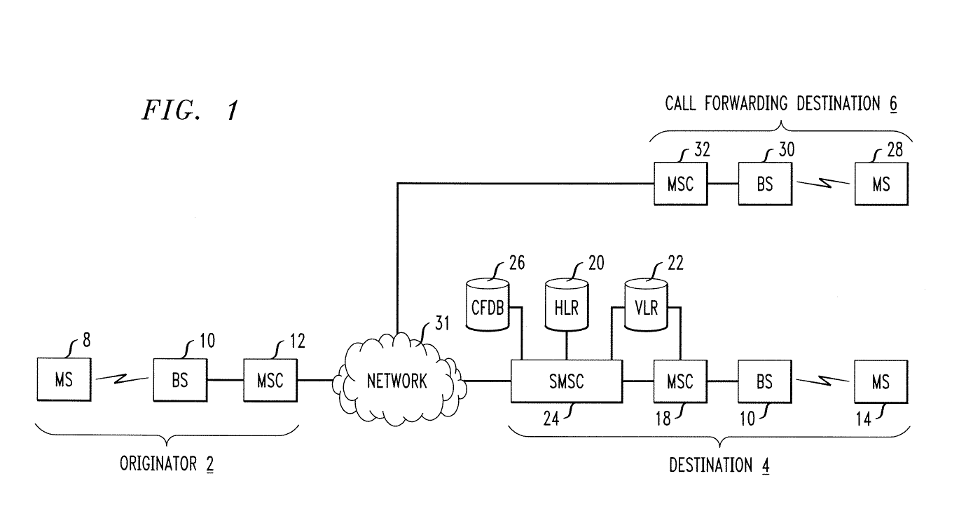

Referring now to the drawings wherein the showings are for purposes of illustrating the exemplary embodiments of the invention only and not for purposes of limiting the claimed subject matter, FIG. 1 provides a view of a system into which the presently described embodiments may be incorporated. As shown generally, FIG. 1 includes an originator 2, a destination 4, and a call forwarding destination 6. The originator 2 includes a first mobile station (MS) 8, a first base station (BS) 10, and a first mobile switching center (MSC) 12. The destination 4 includes a second mobile station 14, a second base station 16, a second mobile switching center 18, a home location register (HLR) 20, and a visitor location register (VLR) 22. The destination further includes a short message service center (SMSC) 24 and a call forwarding database (CFDB) 26. Finally, the call forwarding destination 6 includes a third mobile station 28, a third base station 30, and a third mobile switching center 32.

These network entities or elements represent functional blocks or units that perform various logical functions that are implementation-independent. In other words, one or more of the above-mentioned network entities may be constructed in different physical configurations by different mobile service providers and, therefore, the model shown in FIG. 1 does not imply either a specific physical implementation of a network entity shown therein or a specific interconnection between two or more network entities shown therein. For example, the diagram in FIG. 1 does not show a direct physical interconnection between the VLR 22 and the first MSC 12. The sharing of the VLR 22 may be possible, however, when both of the mobile switching centers 12 and 18 are operated by a common service provider.

It is therefore emphasized that the arrangement shown in FIG. 1 is for illustration only. The network entities shown in FIG. 1 may not represent actual physical connection, especially when call-routing involves many more cells and, thus, many more network entities, in a wireless network. For example, in one embodiment, the first MSC 12 may have its own HLR and VLR (not shown) and may be maintained by a service provider that is different from the service provider maintaining the second MSC 18 and its associated network entities. In short, the network topology in FIG. 1 is a symbolic representation of various functional blocks comprising a wireless network and does not imply a fixed, physical implementation of those functional blocks. A service provider may choose not to provide all the network entities or all the interconnections illustrated in FIG. 1 in a given geographic area or cell. Further, more than one functional unit may be implemented on a single physical device, or, alternatively, some functional blocks may represent separate physical devices.

It is noted that the terms “mobile subscriber,” “network subscriber,” “mobile station,” and “mobile user” may be used interchangeably herein. The mobile stations (MS) 8, 14, and 28 may refer to a human individual who has subscribed to one or more mobile wireless services. The term “mobile station,” as used herein, may also include a mobile service user who uses the subscribed wireless service(s) with a mobile telephone handset or with a computer equipped for wireless communication or with any other similar device. Further, “mobile communication” may include voice, data or any other information communicated via a mobile wireless network. A “mobile station” includes a wireless terminal used by the subscriber to access network services over a radio interface. The wireless terminal may comprise a portable unit (e.g., hand-held unit), a unit installed in a vehicle, or a fixed location unit. The wireless terminal is the interface equipment used to terminate the radio path at the subscriber.

The mobile switching centers (MSC) 12, 18 and 32 are functional entities that represent automatic wireless message switching elements. An MSC may be distinguished from an MTSO (mobile telephone switching office), which may refer more to the physical architecture of the wireless switching office including switching hardware, the physical building, etc. An MSC typically provides interface for user traffic between a cellular network and other public switched networks (PSTNs) or other MSCs in the same or other networks. An MSC provides basic switching functions and coordinates the establishment of calls to and from cellular subscribers. Thus, an MSC is responsible for various call processing, as well as mobile subscriber mobility management, functions.

An MSC first receiving a call placed by a caller (calling a mobile subscriber) may be referred to as the “anchor MSC” (e.g., the first MSC 12), whereas an MSC that finally delivers the call to a mobile subscriber (and thus completes the call) may be referred to as the “serving MSC” (e.g., the second MSC 18 or the third MSC 28). The geographic location of the mobile station at the time of call reception (from the external telephone network, e.g., the Public Switched Telephone Network (PSTN) or another wireless network) determines whether the anchor MSC and the serving MSC are the same or different.

The SMSC 24 is an entity that stores and forwards SMS messages. The SMSC 24 may also provide supplementary services for SMS, which is a packet-switched messaging service that provides store-and-forward functions for the handling of short text messages destined to or originated from the mobile subscribers. Generally, the SMSC 24 is an independent physical entity in the wireless network. Alternatively, it may be part of the HLR 20.

A base station is an entity that provides the means for the mobile station to access network services using radio. Although not shown, it typically includes a base station controller and a base transceiver system. In this regard, the cell phone users may be connected through a base station system 10 for sending SMS messages. The base station system consists of base station controllers and base transceiver stations, and its primary responsibility is to transmit voice and data traffic between the mobile stations.

A wireless network may interconnect with an SS7 (Signaling System No. 7) network 31 as a backbone network to transport IS-41 signaling messages through the mobile telecommunications network. SS7 packets may be used to convey signaling information from an originating point to a destination point through multiple switching nodes in the mobile network, which may encompass more than one wireless network operated by one or more service providers. SS7-based transactions may query databases and invoke functions at remote points throughout the mobile wireless network to establish and maintain calls and to perform reliable call management functions. The SS7 backbone network 31 may be owned and operated by the same service provider as the one operating the interconnected wireless network. Alternatively, a wireless service provider may join an independent SS7 network provider to accomplish desired call routing. Service control points (not shown) are special types of end signaling points in an SS7 network that perform transaction processing of remote operations.

The location registers, i.e., the HLR 20 and the VLR 22, are data-based systems that assist in controlling mobile subscriber services and contain the records and stored information related to mobile subscribers of a particular mobile service provider. The location registers are queried by other network entities to obtain the current status, location, and other information to support calls to and from mobile users within the wireless network. Location registers may also contain network address translation information to assist in the routing of calls to the appropriate network destination.

The HLR 20 is typically a primary database repository of subscriber information used to provide control and intelligence in wireless networks. The HLR 20 thus contains a record of subscriber information such as features selected by the subscriber as part of the mobile service plan, status of the subscriber (e.g., active, inactive, suspended service, etc.), the subscriber's mobile directory number (i.e., the number a calling party has to call to reach the mobile subscriber), information about the current geographic location of the mobile subscriber, etc. The HLR 20 may be shared by more than one MSC. The HLR 20 is generally managed by the wireless service provider company and represents the “home” database of subscribers who have subscribed for the wireless service in that home area served by the wireless service provider.

The VLR 22 is a database that primarily maintains temporary records associated with individual network subscribers. Thus, the VLR 22 represents a “visitor's” database for mobile subscribers who are being served in a defined local area. The VLR 22 is also managed by a wireless service provider. However, the VLR 22 and the HLR 20 may be managed by the same or by different wireless service providers depending on the current geographic location of the mobile subscriber in the wireless network. The term “visitor” may refer to a mobile subscriber who is being served by one or many systems in the home service area, or an MS who is roaming in a non-home, or “visited” service area (i.e., service area of a service provider that is different from the service provider the MS has signed up with). The VLR 22 generally contains subscriber location, status, and service features information that is derived from the relevant HLR, here, HLR 20. The serving MSC (18 or 32) may access its associated VLR to retrieve information for the handling of calls to and from visiting subscribers. Similar to the HLR 20, the VLR 22 may also serve one or more MSCs.

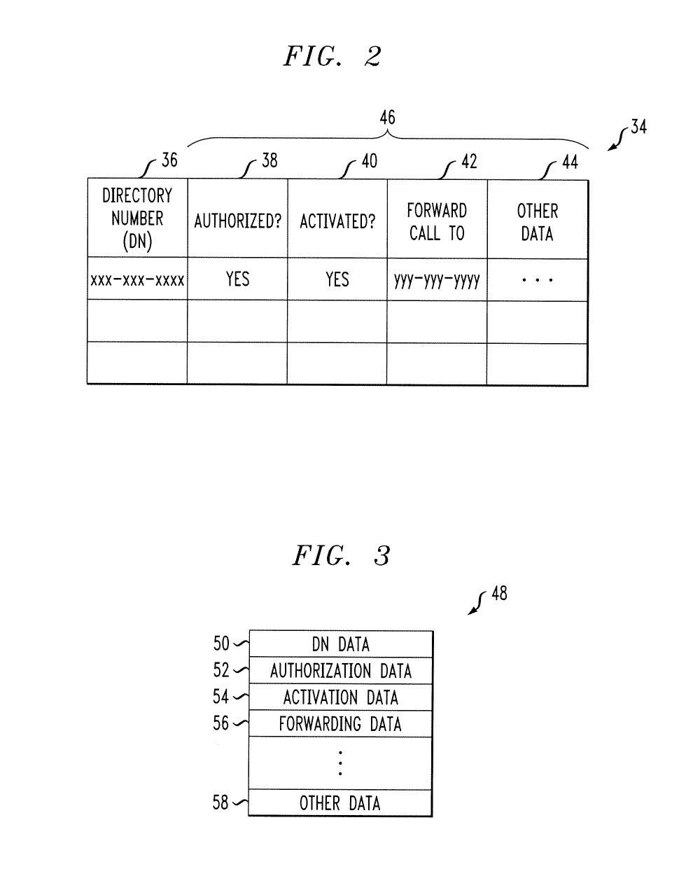

Call forwarding data for SMS messages may be stored in the CFDB 26 in various configurations, such as in a call forwarding table 34 as shown in FIG. 2. The table 34 includes at least one key, in this case, the directory number 36 of the mobile station (e.g., the second mobile station 14). Thus, for each key or directory number 36, there may be any number of associated fields relating to the special call forwarding feature, such as an “Authorized?” field 38, an “Activated?” field 40, a “forward call to” field 42, and one or more additional fields 44 that may be helpful to implement the invention. The “Authorized?” field indicates whether the subscriber has subscribed to the special SMS message forwarding feature. The “Activated?” field indicates whether the subscriber has pressed the appropriate feature activation code (e.g., *777) to activate the SMS message forwarding feature. The “Activated?” field can be marked as “No” if the subscriber deactivates the SMS message forwarding service. The associated fields collectively define an SMS message forwarding record 46 for each directory number 36.

The CFDB 26 may also store call forwarding data for directory numbers in a record (or data block) 48, as shown in FIG. 3. Such a record 48 is shown as a super data block, not all of whose fields (or data sub-blocks) are filled for a particular subscriber. The super data block 48, as known in the art, can be accessed from the identity of any one of several fields (or data sub-blocks) in the super block. As shown, the super block 48 includes any number of data sub-blocks, including a first sub-block 50 that contains DN data (key), a second sub-block 52 that contains data indicating whether SMS message forwarding is authorized for the DN, a third sub-block 54 that contains data indicating whether SMS messageforwarding for the DN is active or not (attribute), and a fourth sub-block 56 that contains call forwarding data. Of course, it is to be understood that any number of additional sub-blocks 58 may be provided in the super block 48 for storing other data.

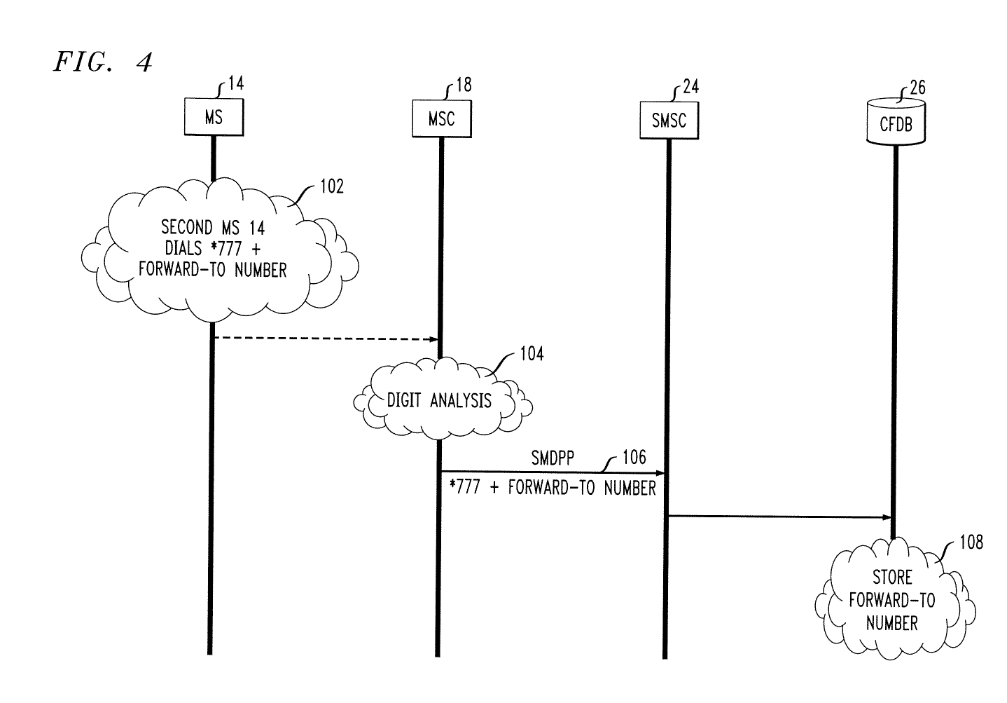

FIG. 4 is a call flow diagram which illustrates a method of provisioning the short message forward-to number.

Initially, the second mobile station 14 dials a specific feature activation code (e.g., *777) followed by a forward-to directory number (e.g. the third mobile station 28) to activate SMS message forwarding (102). Additionally, the SMS message forwarding service could be provisioned and activated via a Web-based mechanism.

The second MSC 18 receives the feature activation code (*777) plus the directory number of the third mobile station 28 and performs digit analysis (104).

Based on the digit analysis, the MSC 18 sends the call forwarding feature activation code and the directory number of the third MS 28 to the SMSC 24 via an SMDPP (Short Message Service Delivery Point to Point) message (106).

The SMSC 24 receives the SMDPP message with the feature activation code for SMS message forwarding and the third MS 28 directory number, and it stores the forward-to directory number (the third MS 28 directory number) for the second MS 14 in the Call Forwarding Database 26 (108).

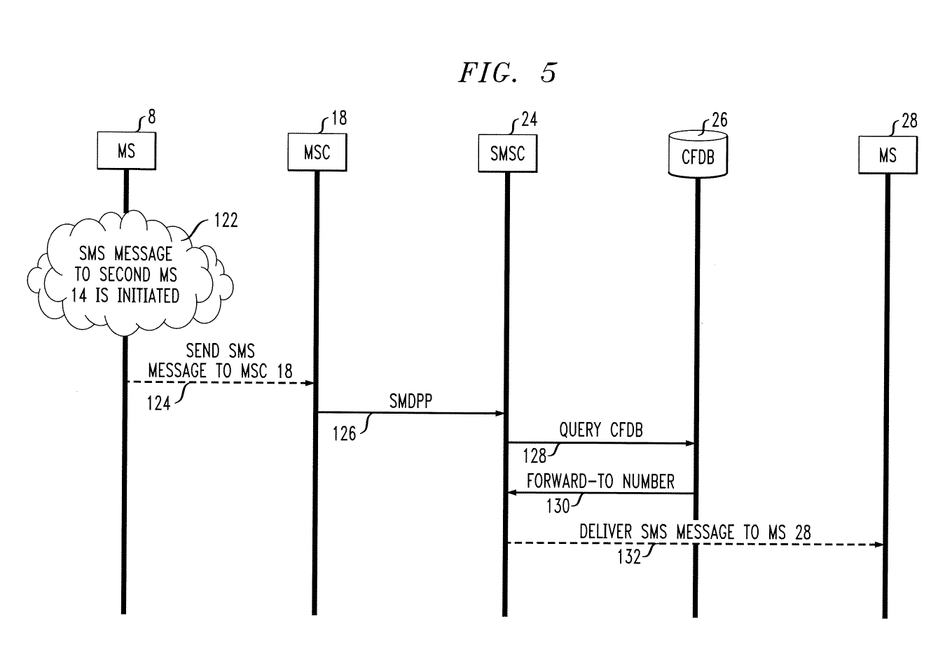

FIG. 5 is a call flow diagram which illustrates a method of forwarding SMS messages in a communications network.

The process begins when the first MS 8 initiates an SMS message to the second MS 14 (122).

The SMS message is then sent to the first MSC 12 (124).

The first MSC 12, in turn, sends an SMDPP message with the short message content to the SMSC 24 (126).

The SMSC 24 receives the SMDPP message and processes the message. In particular, the SMSC 24 queries the CFDB 26 to determine (a) whether the second MS 14 has signed up for SMS message forwarding and (b) whether the second MS 14 has activated the SMS message forwarding feature (128). If the answer to both questions is “yes,” then the SMSC 24 obtains the SMS message forward-to directory number (e.g., the third MS 28) for the second MS 14 (130).

Once the forward-to directory number is obtained, the SMSC 24 delivers the SMS message to the third MS 28 as specified (132).

Of course, the call forwarding feature may be deactivated at any time by dialing a different feature activation code (e.g., *778) or via the Web.

SMS Gateways exist to connect mobile SMS services with instant message (IM) services, the Internet, desktop computers, and even landline telephones (through speech synthesis). Devices which can connect to mobile phones and PDAs through protocols such as Bluetooth can also sometimes use that link to send SMS messages over the wireless network. SMS arose as part of the widely deployed GSM protocol, but is now also available with non-GSM systems. Therefore, it is to be understood that the embodiments disclosed herein work with Internet address, wireline and wireless telephones, WiFi connection, Bluetooth connection, VoIP over DSL, Cable modem, broadband fiber connections, eVPN, IPCentrex connections, WAP connections, etc. This invention also includes originating/terminating address information, message type (SMS, Multi-media Message Service, email), and content type (such as text, audio/video clips, audio/video streams). Thus, these embodiments are applicable for services such as SMS, MMS, video stream, audio tones, etc. running over different types of access networks such as DSL, WiMax, cable, etc. and using IMS services. Moreover, Prepaid, IPCentrex, VPN end-users should be able to control their call-forwarding destinations for various types of multimedia services including SMS, MMS, video, and audio services. The mandatory and optional alert messages should be barred from forwarding. Examples of mandatory messages include Presidential alerts, natural disaster alerts, etc. Optional alerts include amber alerts, weather alerts, etc.

Some portions of the above description were presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “performing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to systems for performing the operations herein. These systems may be specially constructed for the required purposes, or they may comprise one or more general-purpose computers selectively activated or reconfigured by one or more computer programs stored in the computer(s). Such computer program(s) may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems will be apparent from the description. In addition, the present exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, and the like).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of forwarding messages in a wireless network, the method comprising:
receiving a message destined for a first mobile station;
processing the message based on call forwarding data stored in a call forwarding database to make a determination as to whether the message is to be forwarded to a different mobile station; and
transmitting the message to a message center responsive to the determination that the message is to be forwarded to a different mobile station.

2. The method of claim 1 wherein the processing step further comprises:
determining whether the first mobile station has subscribed to a message forwarding service.

3. The method of claim 2 wherein the processing step further comprises:
determining whether the first mobile station has activated the message forwarding service, where the first mobile station has subscribed to the message forwarding service.

4. The method of claim 1 wherein the message comprises a Short Message Service (SMS) message.

5. The method of claim 4 wherein the message is processed at a Short Message Service Center (SMSC).

6. The method of claim 5 further comprising:
receiving an SMS message forwarding service request from the mobile station, wherein the service request includes a feature activation code and a forward-to directory number;
performing digit analysis on the service request; and
sending the service request to the SMSC via a Short Message Service Delivery Point to Point (SMDPP) message based on the digit analysis.

7. The method of claim 6 further comprising:
receiving the SMDPP message with the service request; and
storing the forward-to directory number in a call forwarding database.

8. The method of claim 1 wherein the message comprises a Multi-Media Services (MMS) message.

9. A message forwarding system for a wireless network, the system comprising:
a first network element that receives a message destined for a first mobile station; and
a second network element that processes the message based on call forwarding data stored in a call forwarding database to make a determination as to whether the message is to be forwarded to different mobile station and transmits the message to a message center responsive to the determination that the message is to be forwarded to a different mobile station.

10. The system of claim 9 wherein the second network element determines whether the first mobile station has subscribed to a message forwarding service.

11. The system of claim 10 wherein the second network element determines whether the first mobile station has activated the message forwarding service, where the first mobile station has subscribed to the message forwarding service.

12. The system of claim 9 wherein the message comprises a Short Message Service (SMS) message.

13. The system of claim 12 wherein the second network element comprises a Short Message Service Center (SMSC).

14. The system of claim 13 further comprising:
receiving means for receiving an SMS message forwarding service request from the mobile station, wherein the service request includes a feature activation code and a forward-to directory number;
performing means for performing digit analysis on the service request; and
sending means for sending the service request to the SMSC via a Short Message Service Delivery Point to Point (SMDPP) message based on the digit analysis.

15. The system of claim 14 further comprising:
storing means for receiving the SMDPP message with the service request and storing the forward-to directory number in a Call Forwarding Database.

16. The system of claim 9 wherein the message comprises a Multi-Media Services (MMS) message.
